(19) United States
(12) Patent Application Publication
(10) Pub. No.: US 2011/0225171 A1
(43) Pub. Date: Sep. 15, 2011

(54) SYSTEM AND METHOD FOR PUBLISHING SYNTHESIZED DATA TO FACILITATE PROVIDING INFORMATION AS A SERVICE

(75) Inventors: Moe Khosravy, Bellevue, WA (US); Adam D. Wilson, Seattle, WA (US)

(73) Assignee: MICROSOFT CORPORATION, Redmond, WA (US)

(21) Appl. No.: 12/816,868

(22) Filed: Jun. 16, 2010

Related U.S. Application Data
(60) Provisional application No. 61/313,333, filed on Mar. 12, 2010.

(51) Int. Cl. G06F 17/30

(52) U.S. Cl. 707/748; 707/802; 707/769; 707/E17.044; 707/E17.014

(57) ABSTRACT

Aspects are disclosed for synthesizing data to facilitate providing information as a service. Data contributions from disparate sources are aggregated in which at least a first data contribution is combined with a second data contribution to create a data combination. A consumption of the data combination is then tracked, and a contribution value associated with at least one contributor to the data combination is ascertained based on the consumption.

### CROSS-REFERENCE TO RELATED APPLICATION

This application claims the benefit of U.S. Provisional Patent Application Ser. No. 61/313,333, filed Mar. 12, 2010, which is titled “SYSTEM AND METHOD FOR PUBLISHING SYNTHESIZED DATA TO FACILITATE PROVIDING INFORMATION AS A SERVICE,” and the entire contents of which are incorporated herein by reference.

### BACKGROUND

I. Field

The following description relates generally to an infrastructure for providing information as a service, and more particularly to systems and methods for publishing a synthesis of data to facilitate providing information as a service.

II. Background

By way of background concerning some conventional systems, computing devices have traditionally stored information and associated applications and data services locally to the device. Yet, with the evolution of on-line and cloud services, information is increasingly being moved to network providers who perform none, some or all of the services on behalf of devices. The evolution of network storage farms capable of storing terabytes of data (with potential for petabytes, exabytes, etc. of data in the future) has created an opportunity to mimic the local scenario in a cloud, with separation of the primary device and the external storage.

However, no cloud service or network storage provider has been able to effectively provide information as a service on any platform, with publishers, developers, and consumers easily publishing, specializing applications for and consuming any kind of data, in a way that can be tracked and audited for all involved. This lack of an effective tracking mechanism makes it difficult to valuate information over time since the consumption of particular information may vary and is often unpredictable. Indeed, the valuation of a particular type of data may vary according to consumption, wherein particular subsets of such data may be consumed more often, and thus be more valuable, than others. For instance, with respect to customer satisfaction surveys, responses provided by some customers are inevitably more valuable than others since they might be more thorough, for example, or from a particularly important demographic. Although companies sometimes provide compensation for participating in these surveys, such compensation is often nominal and uniform across all survey participants. Participants thus have little incentive to provide particularly thorough responses and/or from even participating in such surveys at all.

It should be further noted that data is often more valuable in the aggregate. For instance, with respect to the aforementioned customer surveys, the value of a particular survey will generally increase as more customers participate. The actual value of an individual response may thus vary depending on the ultimate comprehensiveness of the survey, as well as an eventual usage of the survey. Conventional systems, however, do not provide an adequate infrastructure for valuating individual contributions to an aggregated dataset. Indeed, unless data is particularly valuable by itself as a single data consuming experience (e.g., data provided via Westlaw®, LexisNexis®, Microsoft Virtual Earth®, the OpenGIS® Web Map Service Interface Standard (WMS), etc.), it is difficult to monetize or otherwise build on the experience beyond the four corners of that valuable data set.

The above-described deficiencies of current methods are merely intended to provide an overview of some of the problems of conventional systems, and are not intended to be exhaustive. Other problems with the state of the art and corresponding benefits of some of the various non-limiting embodiments may become further apparent upon review of the following detailed description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In accordance with one or more embodiments and corresponding disclosure thereof, various aspects are described in connection with providing information as a service from any platform. In one such aspect, an apparatus configured to synthesize data to facilitate providing information as a service is disclosed. Within such embodiment, the apparatus includes a processor configured to execute computer executable components stored in memory. The computer executable components include an aggregation component, a combining component, a tracking component, and a valuation component. The aggregation component is configured to aggregate a plurality of data contributions, whereas the combining component is configured to combine a first data contribution with a second data contribution to create a data combination. For this embodiment, the tracking component is configured to track a consumption of the data combination. The valuation component is then configured to ascertain a contribution value associated with at least one contributor to the data combination based on the consumption.

Other embodiments and various non-limiting examples, scenarios and implementations are described in more detail below.

### BRIEF DESCRIPTION OF THE DRAWINGS

FIG. 1 is an overview of an exemplary system for publishing a synthesis of data in accordance with an aspect of the subject specification.

FIG. 2 is an illustration of an exemplary merging of values according to an embodiment.

FIG. 3 is an illustration of an exemplary joining of datasets according to an embodiment.

FIG. 4 illustrates a block diagram of an exemplary data synthesizer unit in accordance with an aspect of the subject specification.

FIG. 5 is an illustration of an exemplary coupling of components that effectuate publishing a synthesis of data in accordance with an embodiment.

FIG. 6 is a flow chart illustrating an exemplary methodology for publishing synthesized data in accordance with an embodiment.

FIG. 7 illustrates an exemplary mapping of potential information providers over a geographic region according to an embodiment.

FIG. 8 illustrates an exemplary merging of values corresponding to information provider subsets illustrated in FIG. 7.

FIG. 9 illustrates an exemplary allocation of dataset combinations according to an embodiment.

FIG. 10 illustrates an exemplary set of demographic associations which facilitate tracking in accordance with an embodiment.

FIG. 11 illustrates an exemplary merging of weighted values in accordance with an embodiment.

FIG. 12 illustrates an exemplary publishing of information ascertained from joined datasets in accordance with an embodiment.

FIG. 13 is a flow diagram illustrating an exemplary sequence for a non-limiting infrastructure for information provided as a service from any platform.

FIG. 14 is a block diagram illustrating an exemplary non-limiting infrastructure for information provided as a service from any platform.

FIG. 15 is a block diagram illustrating an exemplary non-limiting set of implementation specific details for an infrastructure for information provided as a service from any platform.

FIG. 16 is illustrative of exemplary consumption of data from an exemplary infrastructure for information provided as a service from any platform.

FIG. 17 is a block diagram representing exemplary non-limiting networked environments in which various embodiments described herein can be implemented.

FIG. 18 is a block diagram representing an exemplary non-limiting computing system or operating environment in which one or more aspects of various embodiments described herein can be implemented.

### DETAILED DESCRIPTION

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details. In other instances, well-known structures and devices are shown in block diagram form in order to facilitate describing one or more embodiments.

The subject specification discloses a system and method for publishing synthesized data to facilitate providing information as a service. As used herein, the term “synthesized data” refers to combined data ascertained via any of a plurality of methods including a merging of two or more values into a single merged value and/or a joining of two or more datasets into a single dataset. To this end, it is also contemplated that data combinations may be combined with another data combination and/or data contribution to create a separate data composition (i.e. chaining data combinations/contributions together).

In an aspect, a platform is provided in which content is published and monetized according to a web services application programming interface (API) model that allows tracking and auditing of information consumption transactions. Within such embodiment, even if the content is published for free, due to the auditing and tracking mechanisms described herein, an advertising and revenue engine can be layered on top of content that is actually consumed to ensure that advertising revenues are paid to content publishers in proportion to actual consumption rather than any click-through or other imperfect model. In an aspect, the consumption of a particular content contribution may include the consumption of a data combination that includes the contribution and/or is derived from the contribution. Accordingly, an ecosystem is built in which information providers, including rare publishers, can combine their data with data provided by other information providers and derive revenue based on their respective contributions to the data combination.

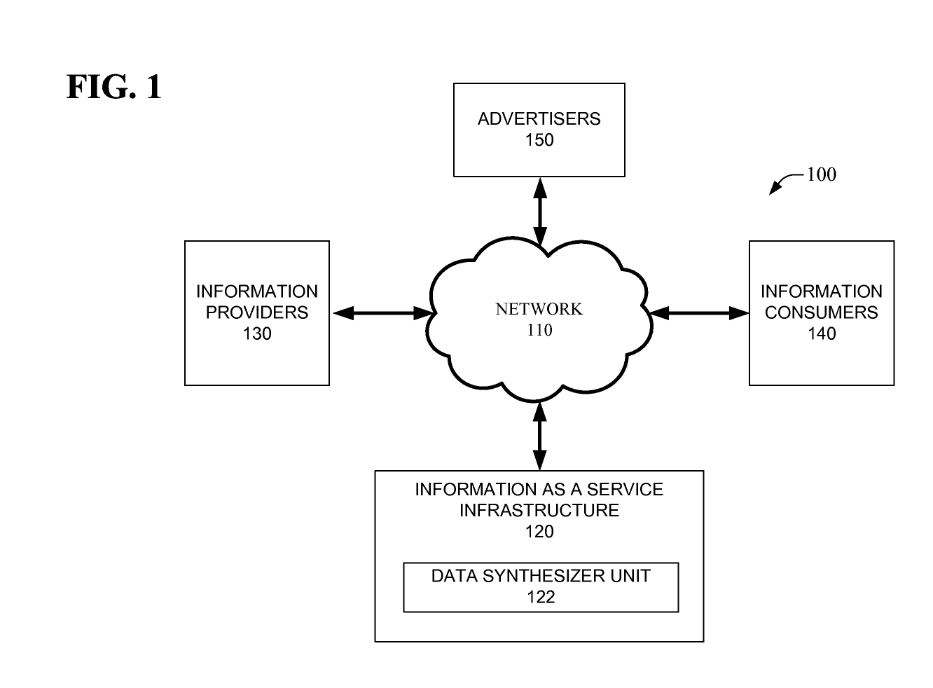

Referring next to FIG. 1, an overview of an exemplary system for publishing synthesized data in accordance with an aspect is shown. As illustrated, system 100 includes information as a service infrastructure 120, information providers 130, information consumers 140, and advertisers 150, which are communicatively coupled via network 110. In an aspect, information as a service infrastructure 120 includes a data synthesizer unit 122 that facilitates providing information as a service by combining data provided by information providers 130 and tracking which information providers 130 contributed to particular data combinations actually consumed by information consumers 140. For instance, although data synthesizer unit 122 may have aggregated weather reports from numerous information providers 130 across the country, individual information consumers 140 may only be interested in obtaining local weather reports. Under such circumstances, only localized subsets of information providers 130 may be used to ascertain corresponding local weather reports. For this example, data synthesizer unit 122 may be configured to identify which information providers 140 contributed to a particularly requested local weather report. In an aspect, data synthesizer 122 may be further configured to insert an advertisement from advertisers 150 into the local weather report, wherein advertising revenue from the inserted advertisement is apportioned to information providers 130 based on their respective contributions to the requested weather report.

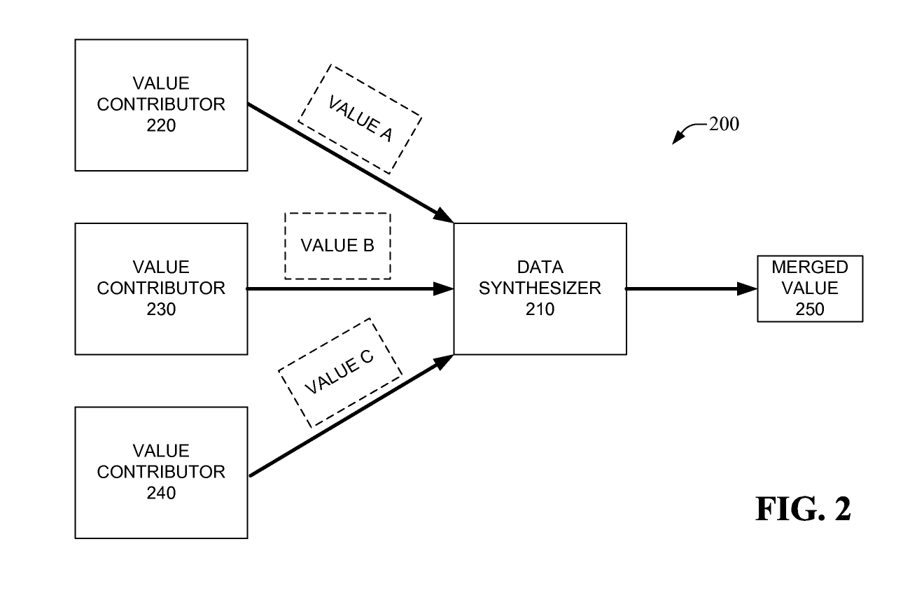

For some applications, it is contemplated that data synthesizer unit 122 may be configured to merge values received from various disparate sources. In FIG. 2, an illustration of an exemplary system for merging such values according to an embodiment is provided. As illustrated, system 200 includes data synthesizer 210 which ascertains merged value 250 based on individual values received from each of value contributor 220, value contributor 230, and value contributor 240. Merged value 250 may, for example, represent an estimated value for a particular home, wherein each of value contributor 220, value contributor 230, and value contributor 240 are distinct home valuation websites. As shown, data synthesizer 210 may receive a “Value A” estimate from value contributor 220, a “Value B” estimate from value contributor 230, and a “Value C” estimate from value contributor 240. In an aspect, data synthesizer 210 may then merge each of the received values into a single merged value 250 (e.g., by averaging Value A, Value B, and Value C, although non-averaging methods are also contemplated), wherein merged value 250 may be assigned a particular confidence level. Such confidence level may be based on any of a plurality of factors including, for instance, sample size (e.g., the number of values from which merged value 250 is based), reliability of the contributors, etc.

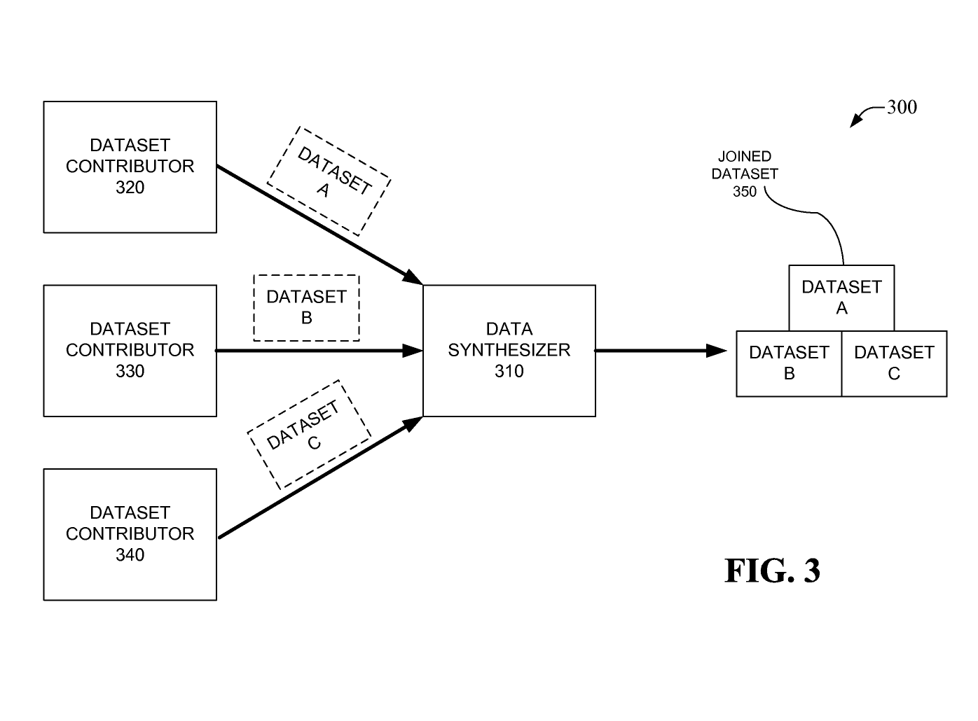

In another aspect, rather than merging values, individual datasets may be joined to form a larger dataset. In FIG. 3, an illustration of an exemplary joining of datasets according to an embodiment is provided. As illustrated, system 300 includes data synthesizer 310 which generates joined dataset 350 based on individual datasets received from each of value contributor 320, value contributor 330, and value contributor 340. Joined dataset 350 may, for example, represent a customer satisfaction survey, wherein each of value contributor 320, value contributor 330, and value contributor 340 are distinct participants of the survey. As shown, data synthesizer 310 may receive a “Dataset A” estimate from value contributor 320, a “Dataset B” estimate from value contributor 330, and a “Dataset C” estimate from value contributor 340. In an aspect, data synthesizer 310 may then join each of the received datasets into a single joined dataset 350. Here, it should be noted that joined dataset 350 may be a searchable dataset of survey responses, wherein some survey responses may be more desirable than others. For instance, an information consumer may perform a search of joined dataset 350 in which only survey responses from people matching a particular demographic are returned. In this example, compensation may be apportioned to only those people matching the desired demographic since they provided the responses consumed via this particular search.

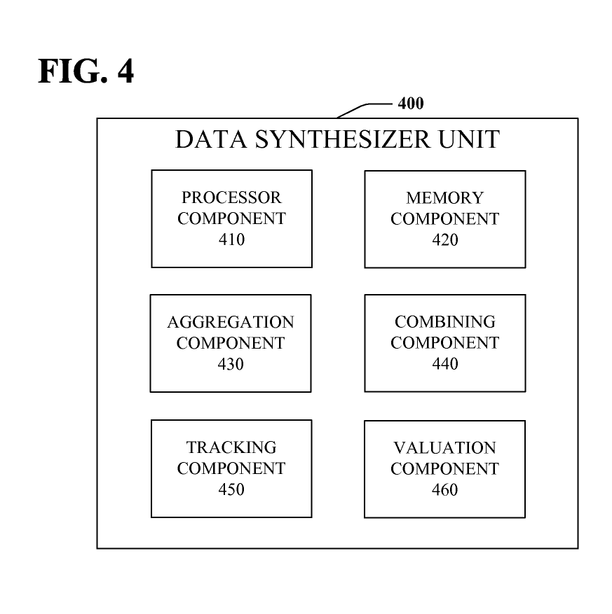

Referring next to FIG. 4, a block diagram of an exemplary data synthesizer unit that facilitates publishing synthesized data according to an embodiment is provided. As shown, data synthesizer unit 400 may include processor component 410, memory component 420, aggregation component 430, combining component 440, tracking component 450, and valuation component 460.

In one aspect, processor component 410 is configured to execute computer-readable instructions related to performing any of a plurality of functions. Processor component 410 can be a single processor or a plurality of processors dedicated to analyzing information to be communicated from data synthesizer unit 400 and/or generating information that can be utilized by memory component 420, aggregation component 430, combining component 440, tracking component 450, and/or valuation component 460. Additionally or alternatively, processor component 410 may be configured to control one or more components of data synthesizer unit 400.

In another aspect, memory component 420 is coupled to processor component 410 and configured to store computer-readable instructions executed by processor component 410. Memory component 420 may also be configured to store any of a plurality of other types of data including data generated by any of aggregation component 430, combining component 440, tracking component 450, and/or valuation component 460. Memory component 420 can be configured in a number of different configurations, including as random access memory, battery-backed memory, hard disk, magnetic tape, etc. Various features can also be implemented upon memory component 420, such as compression and automatic back up (e.g., use of a Redundant Array of Independent Drives configuration).

In yet another aspect, aggregation component 430 is also coupled to processor component 410 and configured to interface data synthesizer unit 400 with information providers. For instance, aggregation component 430 may be configured to aggregate data contributions from any of a plurality of disparate information providers. Here, it should be noted that such data contributions can include qualitative data (e.g., narratives corresponding to a movie review, responses to a survey, etc.) and/or quantitative data (e.g., precipitation measurements, home value estimates, etc.). In an aspect, aggregation component 430 may be further configured to aggregate data contributions based on a search criteria. For instance, based on the search criteria, aggregation component 430 may be configured to aggregate a subset of the already aggregated data contributions (i.e., aggregate internally stored data contributions). Alternatively, aggregation component 430 may be configured to perform the original aggregation based on the search criteria (i.e., aggregate externally stored data contributions).

As shown, data synthesizer unit 400 may also include combining component 440. Within such embodiment, combining component 440 is configured to combine a first data contribution with a second data contribution to create a data combination. In an aspect, the data combination created by combining component 440 can be either a joined dataset or a merged value. For instance, with respect to joining datasets, the first and second data contributions may correspond to qualitative responses to a survey from a first and second information provider, respectively. Here, the data combination may simply include both of the qualitative responses in their entirety. With respect to merged values, however, combining component 440 may be configured to merge a first value associated with the first data contribution with a second value associated with the second data contribution to create the merged value (e.g., an average of two temperature readings from the same neighborhood at the same time). When computing merged values, combining component 440 can be further configured to determine a confidence level associated with the merged value. For instance, combining component 440 can be configured to assign a weight to at least one of the first data contribution or the second data contribution, wherein the confidence level is based on the weight (e.g., weighting the data contributions based on a reliability of their respective sources).

Data synthesizer unit 400 may also include tracking component 450 and valuation component 460, as shown. In an aspect, tracking component 450 is configured to track a consumption of the data combination created by combination component 440, whereas valuation component 460 is configured to ascertain a unique contribution value for each contributor to the data combination based on the consumption. Here, since some information providers may be more valuable than others (e.g., because they are more reliable, more popular, etc.), valuation component 460 may be further configured to assign a particular reputation value to each contributor, wherein the contribution value may vary based on the reputation value.

In a further aspect, it should be appreciated that data synthesizer unit 400 may be configured to apportion revenue generated by providing information as a service (e.g., advertising revenue, subscription revenue, etc.). To facilitate apportioning such revenue, tracking component 450 may be configured to monitor any of a plurality of revenue streams associated with a consumption of information. Moreover, tracking component 450 can be configured to determine an allocation of the revenue stream earned by each contributor of consumed information based on their respective contribution values. In an aspect, data synthesizer unity 400 may provide a centralized advertising platform, wherein advertising revenues are automatically tracked and apportioned. For instance, combining component 430 may be configured to insert an advertisement into a display of a particular data combination, wherein a revenue stream of the data combination includes an advertising portion associated with the inserted advertisement. Here, however, it should be noted that the advertisement might not necessarily be inserted into the display of the data. To this end, it should be further noted that such advertisement may affect the reputation value of one or more contributor, and that the advertisement may be combined with a data contribution to create a data combination.

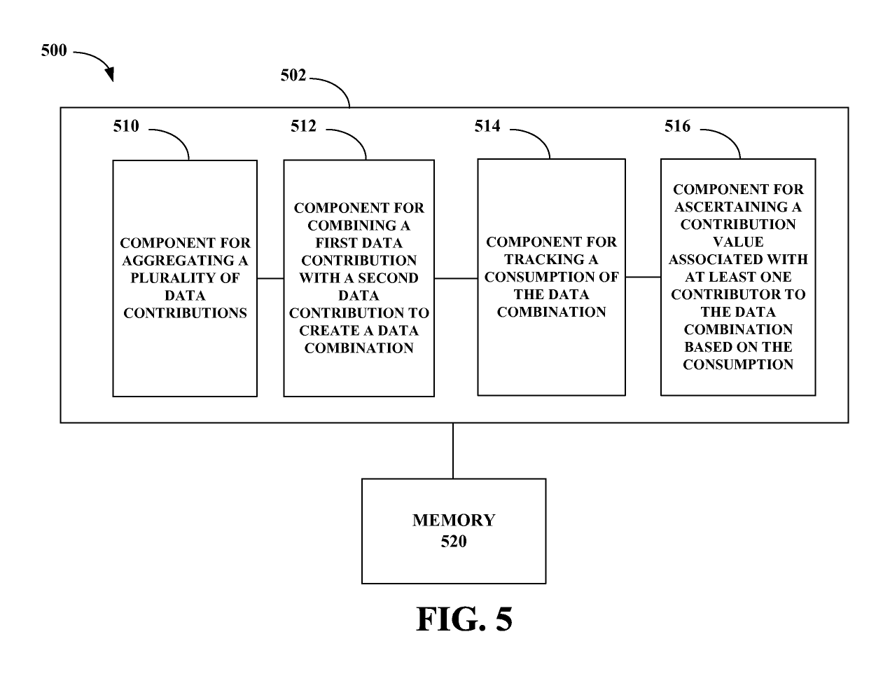

Turning to FIG. 5, illustrated is a system 500 that facilitates publishing a synthesis of data according to an embodiment. System 500 and/or instructions for implementing system 500 can reside within data synthesizer unit 400 or a computer-readable storage medium, for instance. As depicted, system 500 includes functional blocks that can represent functions implemented by a processor, software, or combination thereof (e.g., firmware). System 500 includes a logical grouping 502 of components that can act in conjunction. As illustrated, logical grouping 502 can include a component for aggregating a plurality of data contributions 510, as well as a component for combining a first data contribution with a second data contribution to create a data combination 512. Logical grouping 502 can also include a component for tracking a consumption of the data combination 514. Further, logical grouping 502 can include a component for ascertaining a contribution value associated with at least one contributor to the data combination based on the consumption 516. Additionally, system 500 can include a memory 520 that retains instructions for executing functions associated with components 510, 512, 514, and 516, wherein any of components 510, 512, 514, and 516 can exist either within or outside memory 520.

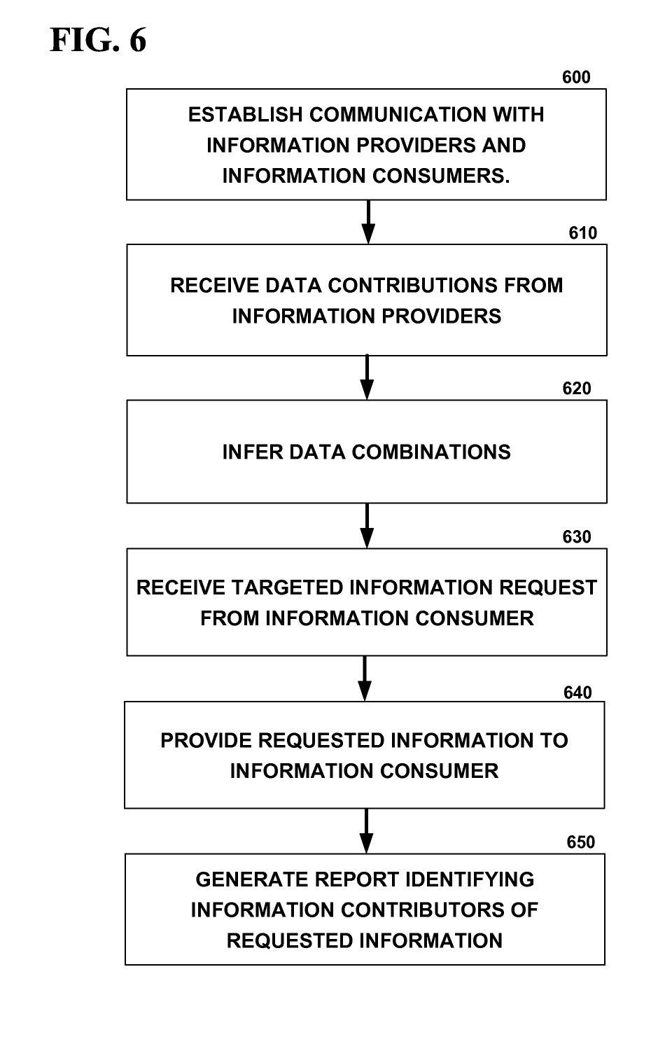

Referring next to FIG. 6, a flow chart illustrating an exemplary method that facilitates publishing synthesized data according to an embodiment is provided. As illustrated, this method includes a series of acts that may be performed by a computing device according to an aspect of the subject specification. For instance, this method may be implemented by employing a processor to execute computer executable instructions stored on a computer readable storage medium to implement the series of acts. In another embodiment, a computer-readable storage medium comprising code for implementing the series of acts is contemplated.

As illustrated, the method begins by establishing a communication link with information providers and information consumers at act 600. Next, at act 610, data contributions from various information providers are received. Upon receiving the data contributions, particular data combinations of the received contributions can then be inferred at act 620. Here, it should be appreciated that some types of quantitative data may be automatically merged (e.g., two people providing a recommendation rating for the same movie). Similarly, qualitative datasets that are logically related may be automatically joined (e.g., two people providing comment narratives for the same movie).

At act 630, the method then proceeds with an information request being received from an information consumer. Here, because any of a wide variety of information may be accessible, it is contemplated that such information request is specifically targeted (e.g., a search string that includes the name of a particular movie). Next, at act 640, the requested information is provided to the information consumer (e.g., recommendation ratings and/or comment narratives for a requested movie). A usage report is then generated at act 650 identifying the information providers who contributed to the requested information (e.g., the people who provided recommendation ratings and/or comment narratives for a requested movie).

### Exemplary Implementations

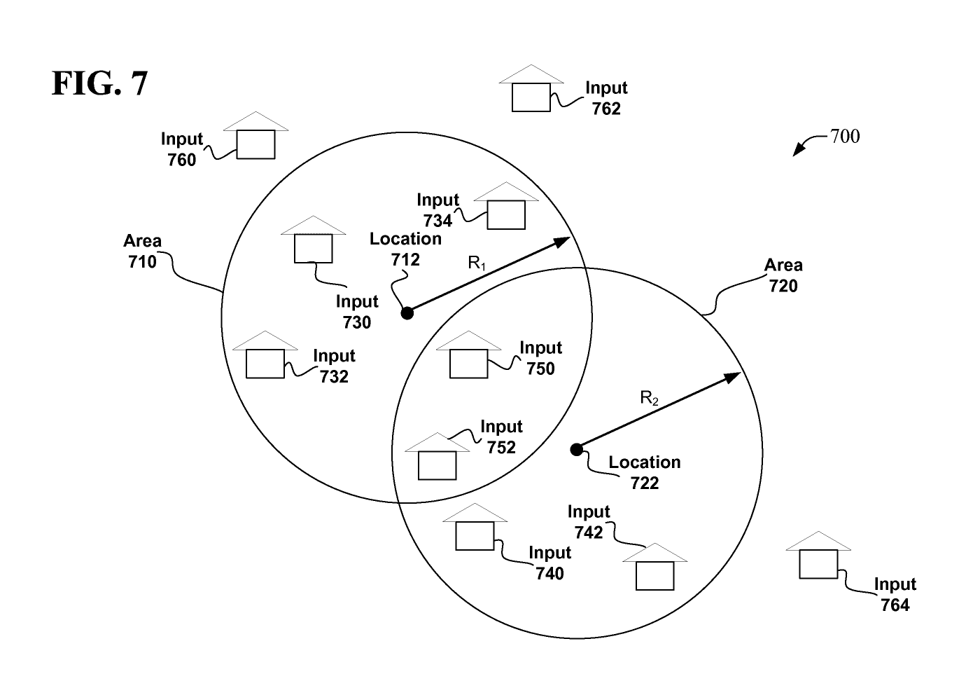

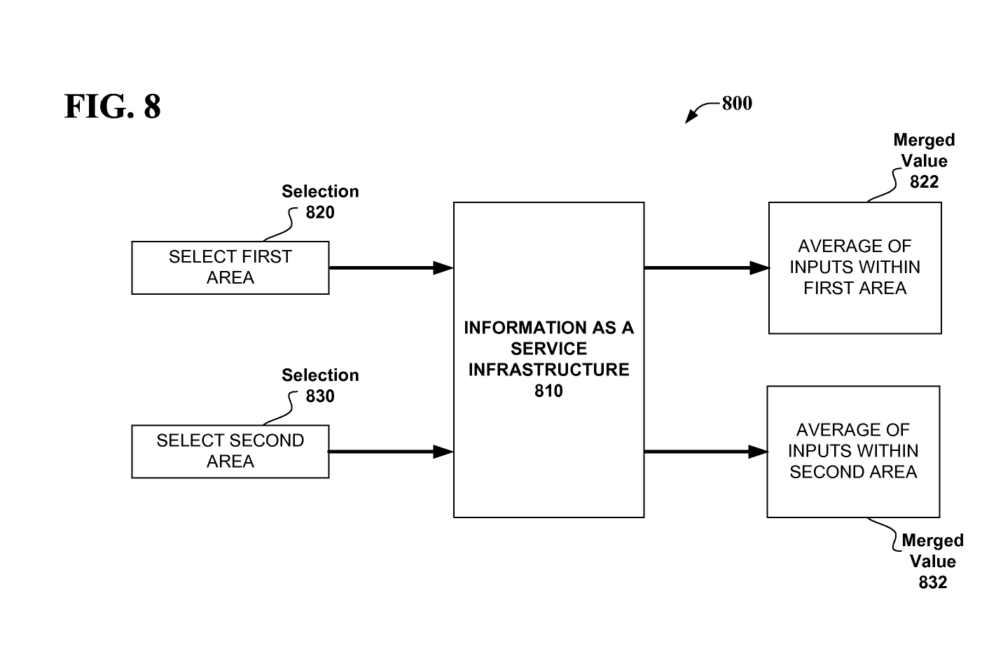

To facilitate a better understanding of the numerous potential implementations of the aspects disclosed herein, the following discussion describes various non-limiting embodiments within the context of exemplary implementation scenarios. Referring first to FIGS. 7-8, an exemplary scenario is provided in which weather temperature readings are aggregated from various information providers. For this particular scenario it is first noted that temperature readings may vary significantly even within the same city. Indeed, conventional weather reports that cover large areas often lack a desired granularity since temperature fluctuations within smaller geographic pockets might be missed.

To overcome this lack of granularity, data can be synthesized from information providers within a selectable geographic region. For instance, FIG. 7 illustrates an exemplary mapping of potential information providers over a particular geographic region. As illustrated, geographic region 700 may include various residences in which a weather temperature reading is received from each residence. For this example, a first information consumer may want a temperature reading centered around location 712 and encompassing area 710, whereas a second information consumer may want a temperature reading centered around location 722 and encompassing area 720. In an aspect, it should be noted that users may select locations 712 and 722, and specify areas 710 and 720, in any of a plurality of ways. For instance, users may simply enter a street address, wherein a circular area encompassing the street address can be automatically generated based on a selectable radius. In this example, area 710 is a circular area having a radius R₁ which encompasses inputs 730, 732, 734, 750, and 752 whereas area 720 is a circular area having a radius R₂ which encompasses inputs 740, 742, 750, and 752. For each of areas 710 and 720, inputs 760, 762, and 764 are excluded.

Referring next to FIG. 8, a block diagram is provided illustrating an exemplary merging of values corresponding to areas 710 and 720, respectively. As illustrated, system 800 includes information as a service infrastructure 810 which receives selections 820 and 830. Here, selection 820 corresponds to a first selected area (i.e., area 710), whereas selection 830 corresponds to a second selected area (i.e., area 720). For this particular example, each of the inputs encompassed by areas 710 and 720 are respectively averaged to ascertain merged values 822 and 832. Furthermore, revenue generated by providing the consumed information (e.g., advertising revenue) can be apportioned to each of the information providers that contributed to merged values 822 and 832.

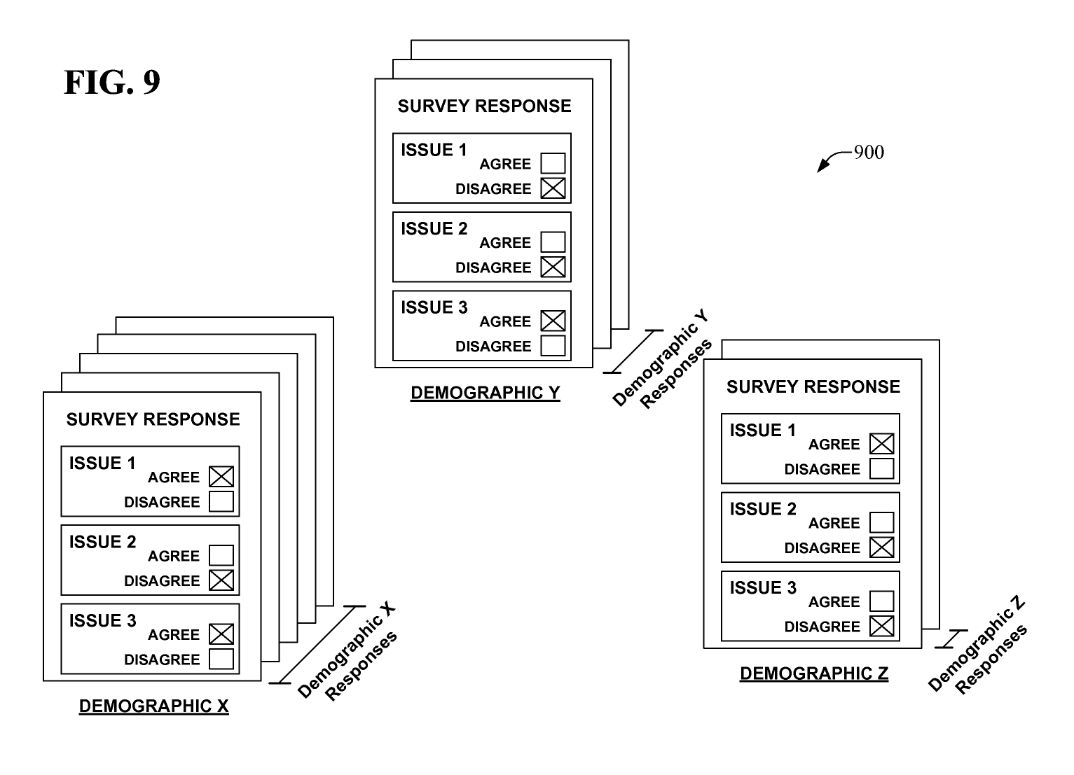

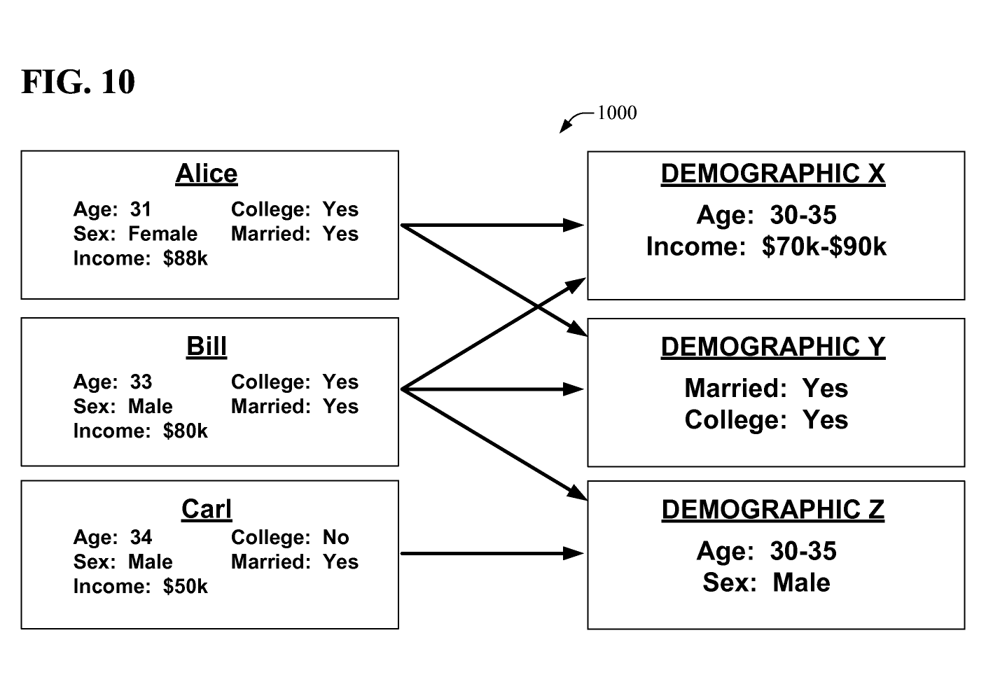

As stated previously, in addition to merging values, it is contemplated that individual datasets may be joined to form a larger dataset. Referring next to FIGS. 9-10, an exemplary scenario is provided in which qualitative datasets are joined within the context of gathering political data. For this particular scenario, it should be noted that political campaigns often invest a significant amount of time and energy researching the popularity of various issues. Indeed, knowing the political pulse of particular demographics is often critical to having a successful campaign. To ascertain this data, surveys which probe the public's views on various issues are utilized. However, participants of such surveys are often offered little or no compensation, which discourages many people from participating at all.

In order to provide more incentive to participate in such surveys, the aspects described herein can be implemented to identify particularly useful survey responses so that providers of those responses can be compensated accordingly. In FIG. 9, an exemplary allocation of survey responses is provided according to an embodiment. As illustrated, allocation 900 includes three datasets respectively corresponding to Demographics X, Y, and Z, wherein Demographic X is shown to have the most responses, followed by Demographic Y with the next most and Demographic Z with the least responses.

Here, it should be noted that survey responses from responders matching particular demographics may be more valuable than others. For example, survey responses submitted by responders in “swing” states may generally be deemed more valuable than responses from non-swing states. If so, such distinction in value can be readily quantified by monitoring the actual consumption of these responses.

In an aspect, the tracking aspects described herein can then be utilized in conjunction with this valuation to apportion revenues to survey responders based on consumption. For instance, as illustrated in FIG. 10, individual survey responders may be associated with multiple demographics. For this particular set of associations 1000, Alice is associated with Demographics X and Y, Bill is associated with Demographics X, Y, and Z, and Carl is associated with Demographic Z. Therefore, by tracking a consumption of datasets corresponding to each demographic, a consumption-based apportioning of revenues can be implemented to compensate each of Alice, Bill, and Carl accordingly. Namely, Alice is compensated when survey data pertaining to Demographics X and Y is consumed, Bill is compensated when survey data pertaining to Demographics X, Y, and Z is consumed, and Carl is compensated when survey data pertaining to Demographic Z is consumed.

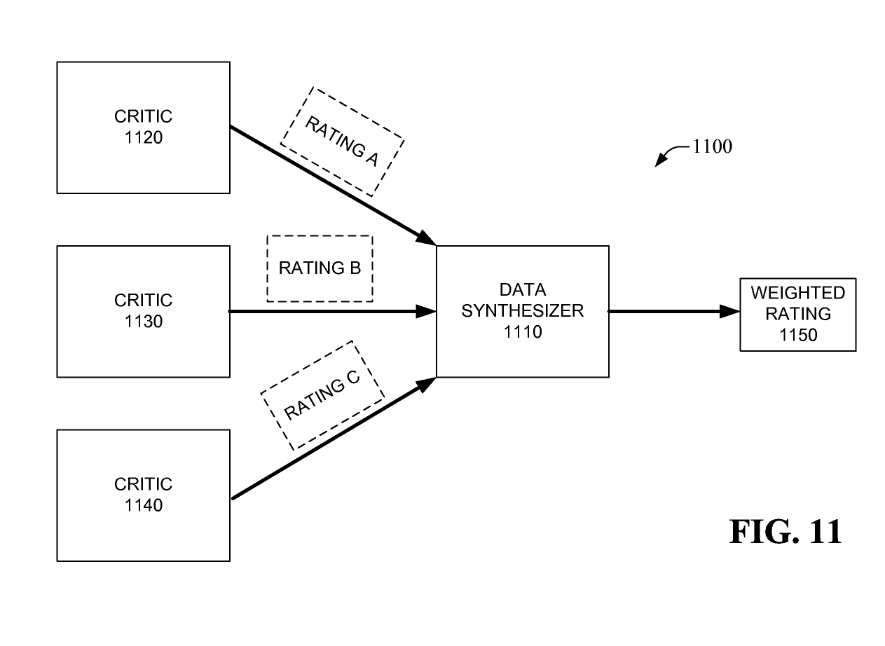

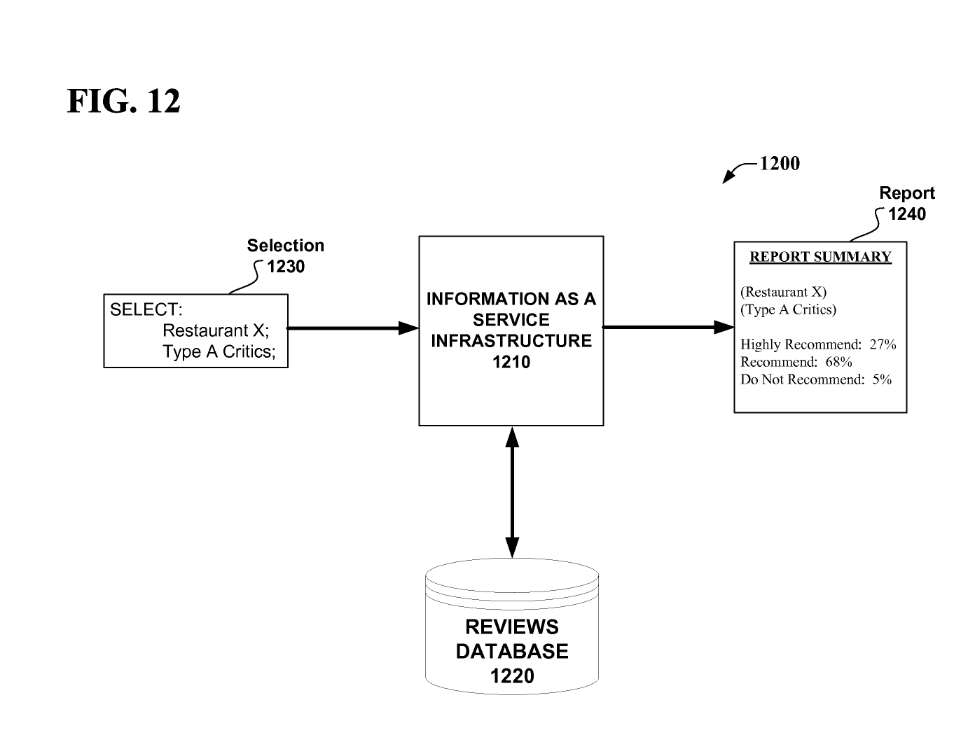

As stated previously, it may sometimes be desirable to compensate information providers according to their respective reputations. Referring next to FIGS. 11-12, an exemplary scenario is provided in which data is synthesized according to reputation within the context of restaurant reviews. For this scenario, it is noted that reviews from particular restaurant critics may be inherently more valuable than other critics. For example, a review provided by a professional restaurant critic may be more valuable than a review provided by an amateur. Similarly, a review from a novice online critic with a large following (e.g., popular Yelp reviewers) may be more valuable than a review from a novice critic with a smaller following. Indeed, by implementing the aspects described herein, even such novice restaurant critics can now be compensated for reviews that they previously provided for free.

In an aspect, reputation values are integrated into merged value calculations by weighting data contributions accordingly. In FIG. 11, an illustration of an exemplary merging of weighted values according to an embodiment is provided. As illustrated, system 1100 includes data synthesizer 1110 which ascertains weighted rating 1150 based on individual ratings received from each of critic 1120, critic 1130, and critic 1140. Weighted rating 1150 may, for example, represent a quality rating for a particular restaurant, wherein ratings provided by each of critic 1120, critic 1130, and critic 1140 are weighted according to their particular reputation values (e.g. by assigning a unique multiplier to each reputation value). As shown, data synthesizer 1110 may receive a “Rating A” from critic 1120, a “Rating B” from 1130, and a “Rating C” from critic 1140. In an aspect, data synthesizer 1110 may then merge each of the received ratings into a single weighted rating 1150 (e.g., by weighting each Rating based on reputation and then averaging), wherein weighted rating 1150 may be assigned a particular confidence level. Such confidence level may be based on any of a plurality of factors including, for instance, sample size (e.g., the number of ratings from which weighted rating 1150 is based), reputation of the contributing critics, etc. Furthermore, in addition to weighting each individual rating based on reputation, compensation from a consumption of weighted rating 1150 may also be weighted. Indeed, since a weighted rating may have a higher confidence level, such rating may be more desirable to information consumers and hence more valuable.

In another aspect, qualitative reviews from individual critics may be joined to form a larger dataset. In FIG. 12, an exemplary system for joining reviews from individual critics in accordance with an embodiment is provided. As illustrated, system 1200 includes data synthesizer 1210 which generates report 1240 by joining particular reviews in reviews database 1220 based on selection 1230. In this example, selection 1230 indicates that the user is requesting reviews for “Restaurant X” submitted by “Type A” critics (e.g., critics with the highest reputation values). Therefore, upon receiving selection 1230, data synthesizer 1210 retrieves all reviews for “Restaurant X” submitted by “Type A” critics from reviews database 1220. Data synthesizer 1210 may then generate report 1240 based on the retrieved reviews, wherein qualitative recommendation ratings for “Restaurant X” submitted by “Type A” critics are summarized. For this particular example, since contributions from “Type A” critics were used to generate report 1240, the “Type A” critics can then be compensated accordingly.

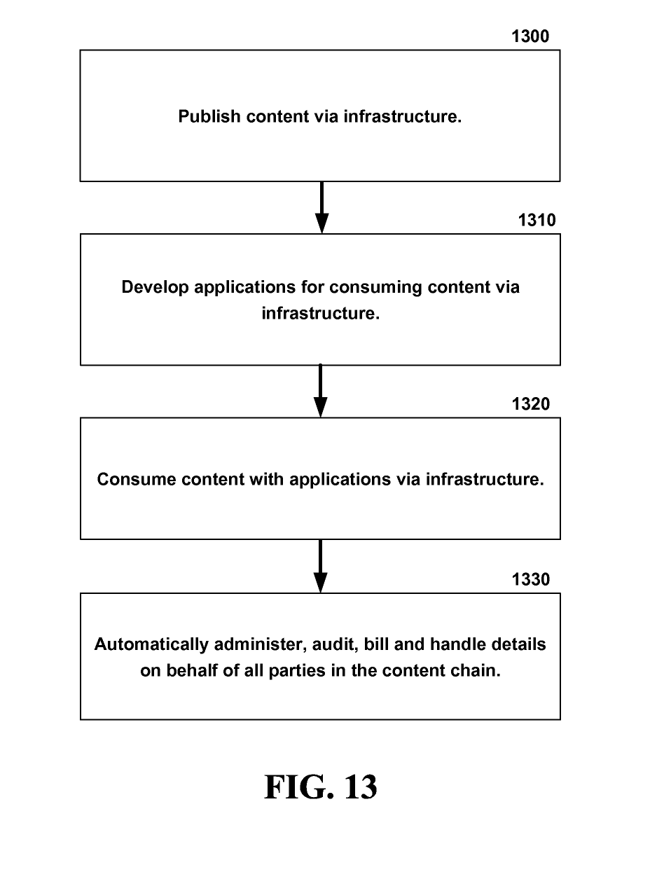

As shown in the flow diagram of FIG. 13, at 1300, described herein are various ways for content owners or publishers to publish data via the infrastructure. At 1310, there are a variety of tools that allow developers to developer applications for consuming the data via the infrastructure. At 1320, consumers or information workers use the applications or can directly query over the data to consume the data. Lastly, the infrastructure provides a rich variety of tools at 1330 that enable automatic administration, auditing, billing, etc. on behalf of all parties in the content chain, enabled by the transaction model.

In this regard, some key parties in the infrastructure include data owners, the application developers/ISVs and the consumers/information workers. In general, data owners are entities who want to charge for data, or who want to provide data for free for other reasons, or enforce other conditions over the data. In turn, application developers/ISVs are entities who want to monetize their application (e.g., through advertising, direct payments, indirect payments, etc.), or provide their application for free for some beneficial reason to such entities. Information workers and consumers are those who can use the raw data, or those who want to use an application provided by the application developers.

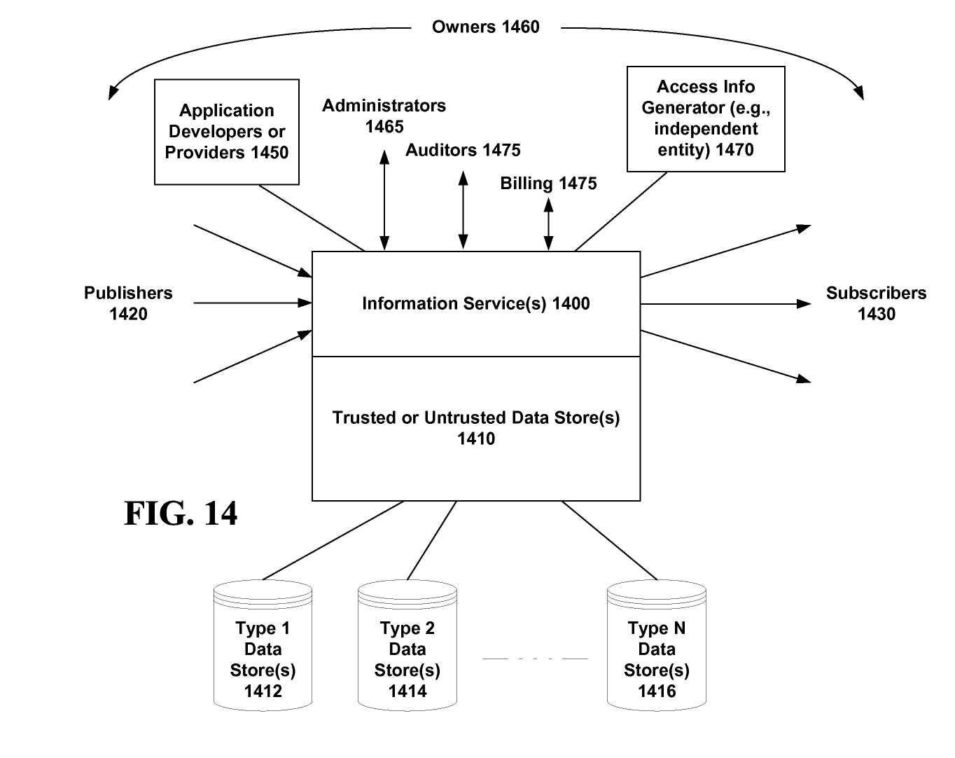

FIG. 14 is a block diagram generally illustrating the various parties that may participate in an ecosystem providing information as a service as described herein. For instance a set of network accessible information services 1400 provide access to a variety of trusted or untrusted data stores 1410, depending on the sensitivity or other characteristics of the data. As shown, thus, what type of data store, 1412, 1414, . . . , 1416 is not so important since the ecosystem supports any kind of data, blob, structured, unstructured, etc. As mentioned, the system includes publishers 1420 that add data to the ecosystem, subscribers 1430 that consume the data and application developers or providers 1450 who help consumption of the data with their applications. An access information generator 1470 can also govern access to the data by various parties through maintaining or enforcing account information, key information, etc. In this respect, content owners 1460 can span any of the roles in that a content owner 1460 can be a publisher 1420, a subscriber 1430 and/or an application developer as well. In one aspect, the common infrastructure for all parties enables administration 1465, auditing 1475, billing 1475 as well as other desired ancillary services to the data transactions occurring across the infrastructure.

In this regard, various embodiments for the user friendly data platform for enabling information as a service from any platform is an infrastructure to enable consumers of data (IWs, developers, ISVs) and consumers of data to transact in a simple, cost effective and convenient manner. The infrastructure democratizes premium (private) and community (public) data in an affordable way to allow IWs to draw insights rapidly, and allows developers to build innovative apps using multiple sources of data in a creative manner and enables developers to monetize their efforts on any platform. For instance, the infrastructure supports Pay Per Use as well as Subscription Pricing for Content, Pay for Content (“retail price”—set by content owner), Pay Data Fee (“Shipping and Handling”) and BW, and further supports Data fees as a brokerage fee on a per-logical transaction basis (per report, per API, per download, etc.).

For Information Workers (e.g., Office, SQL Server, Dynamics users), the infrastructure supports subscriptions to allow for future EA integration as well as predictable spend requirements (as well as caching to support on and off-premise BI as well as “HPC” workloads). Thus, alternatives include content priced per-user per-month; which may or may not bundle to deliver content packs or per-transaction pricing, e.g., allowing cloud reporting/business intelligence on-demand pricing to eliminate the need to move large amounts of data while allowing per-usage pricing, or vertical apps via report galleries.

For content providers (any data type; any cloud), using any platform, the infrastructure becomes a value proposition to incent sales within any particular desired platform; auto-scaling, higher level SLA possibilities at no additional cost. For some non-limiting examples, data can be secure and associated data in the following domains: Location aware services & data, Commercial and residential real estate, Financial data and services, etc. A non-limiting scenario may include delivery of data to top 30 non-governmental organization (NGO) datasets. In addition, the infrastructure may include the ability to showcase BI & visualization through “Bing for information as a service”, HPC, etc. Vertical application opportunities exist as well.

In one non-limiting embodiment, the data brokerage can be analogized to conventional brick and mortar strategies: For instance, capacity can be represented as shelf space (e.g., a mix of structured and unstructured/blob data), cost of goods (COGS) can be represented as square footage, (SA, platform dependency, bandwidth) and content can be represented as merchandise (e.g., optimize content providers to cover COGS, maximize profits from IWs and developers). In various embodiments, an onboarding process can be implemented with quality bars for data and services, as well as accommodation of service level agreements (SLAs).

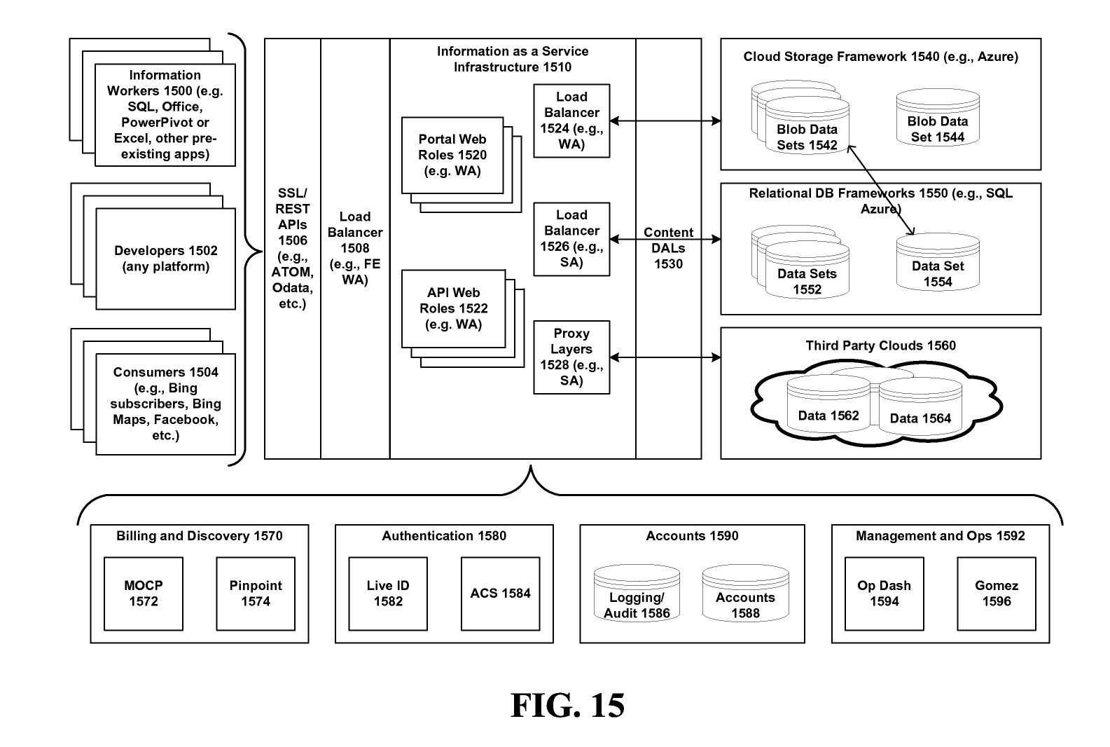

FIG. 15 is an exemplary non-limiting implementation of the infrastructure 1510 for information as a service as described above according to one or more features. At the interaction side are information workers 1500, developers 1502 and consumers 1504 who can communicate with the infrastructure via SSL/REST based APIs 1506. A load balancer 1508 can be used to help steer traffic in an optimal way. In this regard, the input is routed to portal web roles 1520 or API web roles 1522. From the infrastructure 1510 to the data side is additional load balancing 1524 or 1526 (e.g., WA or SA) for access to blob data sets 1542, or blob data set 1555 of cloud storage framework 1540, or to data sets 1552 or data set 1554 of relational database frameworks 1550. Proxy layers 1528 can be used to access data 1562 or data 1564 of third party clouds 1560. Content data abstract layers (DALs) 1530 can be used to access content, where applicable. In this regard, there can be duplication or overlap of data sets across different types of storage, e.g., the same data might be represented as blob data and as structured data, e.g., SQL.

As supplemental services to the data, billing and discovery services 1570 can include online billing 1572 (e.g., MOCP) or discovery services 1574 (e.g., pinpoint) and authentication services 1580 can include credentials management 1582 (e.g., Live ID) or content authentication 1584, e.g., authenticated content services (ACS). Accounts services 1590 can include logging/audit services 1586 or account management 1588. Management and operations services 1592 can include an operations dashboard service 1594 and network operations service 1596, e.g., Gomez.

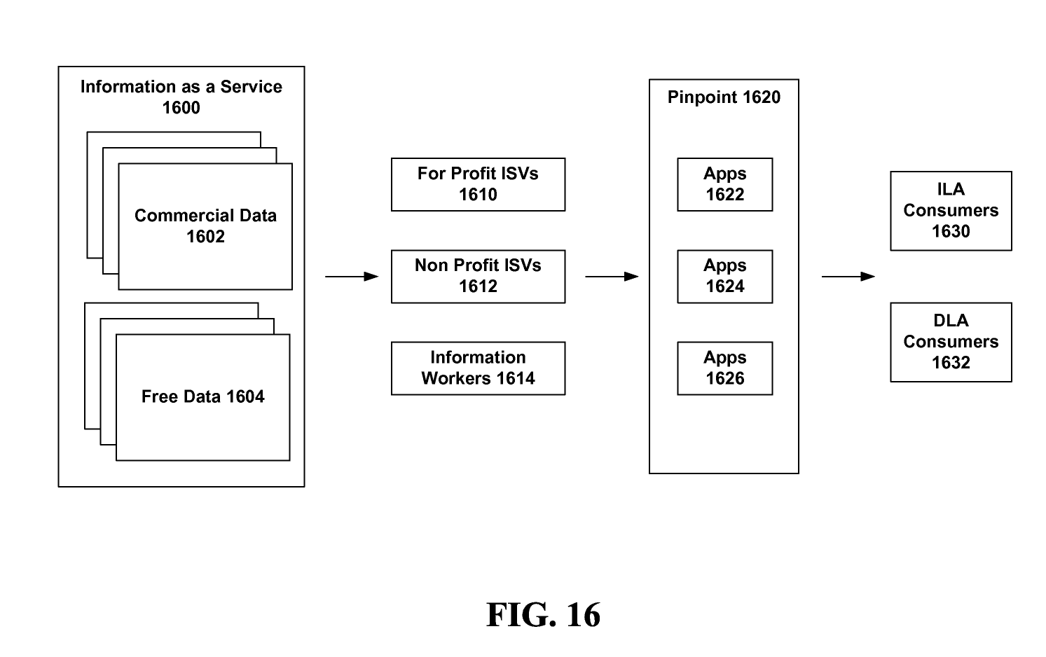

FIG. 16 is a block diagram illustrating an exemplary end to end flow from data to consumers of the data in accordance with one or more embodiments of the general infrastructure for enabling information as a service. For instance, information as a service 1600 can include commercial data 1602 and free data 1604, which can be of interest to various for profit developers 1610, nonprofit developers 1612 with non-profit motives and other information workers 1614 who are interested in consuming the data generally for productive goals. These entities can use discovery services 1620 to determine what applications 1622, 1624, . . . , 1626 may be of interest to them, and to ultimately transmit the data to ILA consumers 1630 and DLA consumers 1632 alike.

### Exemplary Networked and Distributed Environments

One of ordinary skill in the art can appreciate that the various embodiments of methods and devices for an infrastructure for information as a service from any platform and related embodiments described herein can be implemented in connection with any computer or other client or server device, which can be deployed as part of a computer network or in a distributed computing environment, and can be connected to any kind of data store. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

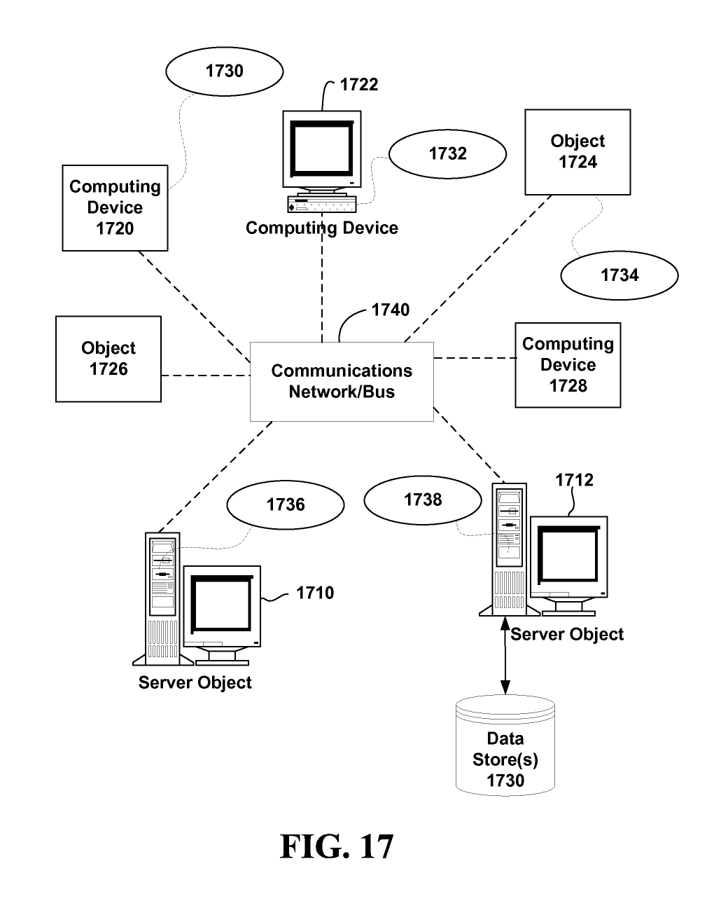

FIG. 17 provides a non-limiting schematic diagram of an exemplary networked or distributed computing environment. The distributed computing environment comprises computing objects 1710, 1712, etc. and computing objects or devices 1720, 1722, 1724, 1726, 1728, etc., which may include programs, methods, data stores, programmable logic, etc., as represented by applications 1730, 1732, 1734, 1736, 1738. It can be appreciated that objects 1710, 1712, etc. and computing objects or devices 1720, 1722, 1724, 1726, 1728, etc. may comprise different devices, such as PDAs, audio/video devices, mobile phones, MP3 players, laptops, etc.

Each object 1710, 1712, etc. and computing objects or devices 1720, 1722, 1724, 1726, 1728, etc. can communicate with one or more other objects 1710, 1712, etc. and computing objects or devices 1720, 1722, 1724, 1726, 1728, etc. by way of the communications network 1740, either directly or indirectly. Even though illustrated as a single element in FIG. 17, network 1740 may comprise other computing objects and computing devices that provide services to the system of FIG. 17, and/or may represent multiple interconnected networks, which are not shown. Each object 1710, 1712, etc. or 1720, 1722, 1724, 1726, 1728, etc. can also contain an application, such as applications 1730, 1732, 1734, 1736, 1738, that might make use of an API, or other object, software, firmware and/or hardware, suitable for communication with or implementation of an infrastructure for information as a service from any platform as provided in accordance with various embodiments.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the techniques as described in various embodiments.

Thus, a host of network topologies and network infrastructures, such as client/server, peer-to-peer, or hybrid architectures, can be utilized. In a client/server architecture, particularly a networked system, a client is usually a computer that accesses shared network resources provided by another computer, e.g., a server. In the illustration of FIG. 17, as a non-limiting example, computers 1720, 1722, 1724, 1726, 1728, etc. can be thought of as clients and computers 1710, 1712, etc. can be thought of as servers where servers 1710, 1712, etc. provide data services, such as receiving data from client computers 1720, 1722, 1724, 1726, 1728, etc., storing of data, processing of data, transmitting data to client computers 1720, 1722, 1724, 1726, 1728, etc., although any computer can be considered a client, a server, or both, depending on the circumstances. Any of these computing devices may be processing data, or requesting services or tasks that may implicate an infrastructure for information as a service from any platform and related techniques as described herein for one or more embodiments.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the user profiling can be provided standalone, or distributed across multiple computing devices or objects.

In a network environment in which the communications network/bus 1740 is the Internet, for example, the servers 1710, 1712, etc. can be Web servers with which the clients 1720, 1722, 1724, 1726, 1728, etc. communicate via any of a number of known protocols, such as HTTP. Servers 1710, 1712, etc. may also serve as clients 1720, 1722, 1724, 1726, 1728, etc., as may be characteristic of a distributed computing environment.

### Exemplary Computing Device

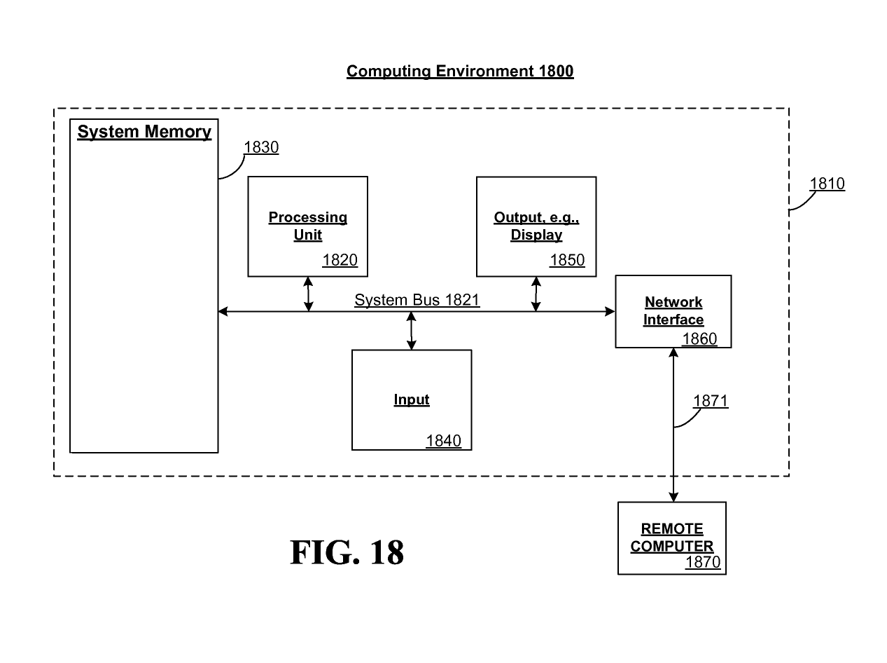

As mentioned, various embodiments described herein apply to any device wherein it may be desirable to implement one or pieces of an infrastructure for information as a service from any platform. It should be understood, therefore, that handheld, portable and other computing devices and computing objects of all kinds are contemplated for use in connection with the various embodiments described herein, i.e., anywhere that a device may provide some functionality in connection with an infrastructure for information as a service from any platform. Accordingly, the below general purpose remote computer described below in FIG. 18 is but one example, and the embodiments of the subject disclosure may be implemented with any client having network/bus interoperability and interaction.

Although not required, any of the embodiments can partly be implemented via an operating system, for use by a developer of services for a device or object, and/or included within application software that operates in connection with the operable component(s). Software may be described in the general context of computer executable instructions, such as program modules, being executed by one or more computers, such as client workstations, servers or other devices. Those skilled in the art will appreciate that network interactions may be practiced with a variety of computer system configurations and protocols.

FIG. 18 thus illustrates an example of a suitable computing system environment 1800 in which one or more of the embodiments may be implemented, although as made clear above, the computing system environment 1800 is only one example of a suitable computing environment and is not intended to suggest any limitation as to the scope of use or functionality of any of the embodiments. Neither should the computing environment 1800 be interpreted as having any dependency or requirement relating to any one or combination of components illustrated in the exemplary operating environment 1800.

With reference to FIG. 18, an exemplary remote device for implementing one or more embodiments herein can include a general purpose computing device in the form of a handheld computer 1810. Components of handheld computer 1810 may include, but are not limited to, a processing unit 1820, a system memory 1830, and a system bus 1821 that couples various system components including the system memory to the processing unit 1820.

Computer 1810 typically includes a variety of computer readable media and can be any available media that can be accessed by computer 1810. The system memory 1830 may include computer storage media in the form of volatile and/or nonvolatile memory such as read only memory (ROM) and/or random access memory (RAM). By way of example, and not limitation, memory 1830 may also include an operating system, application programs, other program modules, and program data.

A user may enter commands and information into the computer 1810 through input devices 1840 A monitor or other type of display device is also connected to the system bus 1821 via an interface, such as output interface 1850. In addition to a monitor, computers may also include other peripheral output devices such as speakers and a printer, which may be connected through output interface 1850.

The computer 1810 may operate in a networked or distributed environment using logical connections to one or more other remote computers, such as remote computer 1870. The remote computer 1870 may be a personal computer, a server, a router, a network PC, a peer device or other common network node, or any other remote media consumption or transmission device, and may include any or all of the elements described above relative to the computer 1810. The logical connections depicted in FIG. 18 include a network 1871, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices, networks and advertising architectures, the underlying concepts may be applied to any network system and any computing device or system in which it is desirable to publish, build applications for or consume data in connection with interactions with a cloud or network service.

There are multiple ways of implementing one or more of the embodiments described herein, e.g., an appropriate API, tool kit, driver code, operating system, control, standalone or downloadable software object, etc. which enables applications and services to use the infrastructure for information as a service from any platform. Embodiments may be contemplated from the standpoint of an API (or other software object), as well as from a software or hardware object that facilitates provision of an infrastructure for information as a service from any platform in accordance with one or more of the described embodiments. Various implementations and embodiments described herein may have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the disclosed subject matter will be better appreciated with reference to the flowcharts of the various figures. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

While in some embodiments, a client side perspective is illustrated, it is to be understood for the avoidance of doubt that a corresponding server perspective exists, or vice versa. Similarly, where a method is practiced, a corresponding device can be provided having storage and at least one processor configured to practice that method via one or more components.

While the various embodiments have been described in connection with the preferred embodiments of the various figures, it is to be understood that other similar embodiments may be used or modifications and additions may be made to the described embodiment for performing the same function without deviating there from. Still further, one or more aspects of the above described embodiments may be implemented in or across a plurality of processing chips or devices, and storage may similarly be affected across a plurality of devices. Therefore, the present invention should not be limited to any single embodiment, but rather should be construed in breadth and scope in accordance with the appended claims.

What is claimed is:

1. A method for synthesizing data to facilitate providing information as a service, comprising:
employing a processor to execute computer executable instructions stored on a computer readable storage medium to implement a series of acts including:
aggregating a plurality of data contributions;
combining a first data contribution with a second data contribution to create a data combination;
tracking a consumption of the data combination; and
ascertaining a contribution value associated with at least one contributor to the data combination, the contribution value based on the consumption.

2. The method of claim 1, wherein the data combination is a merged value, the combining comprising merging a first value associated with the first data contribution with a second value associated with the second data contribution to create the merged value.

3. The method of claim 2, further comprising determining a confidence level associated with the merged value.

4. The method of claim 1, wherein the data combination is a joined dataset, the combining comprising joining a first dataset associated with the first data contribution with a second dataset associated with the second data contribution to create the joined dataset.

5. The method of claim 1, further comprising aggregating the plurality of data contributions based on a search criteria, the first data contribution and the second data contribution included in a set of results matching the search criteria.

6. The method of claim 1, wherein the plurality of data contributions include qualitative data.

7. The method of claim 1, wherein the plurality of data contributions include quantitative data.

8. The method of claim 1, further comprising associating a reputation value with the at least one contributor, the contribution value based on the reputation value.

9. The method of claim 1, further comprising monitoring a revenue stream associated with the consumption.

10. An apparatus configured to synthesize data to facilitate providing information as a service, the apparatus comprising:
a processor configured to execute computer executable components stored in memory, the components including:
an aggregation component configured to aggregate a plurality of data contributions;
a combining component configured to combine a first data contribution with a second data contribution to create a data combination;
a tracking component configured to track a consumption of the data combination; and
a valuation component configured to ascertain a contribution value associated with at least one contributor to the data combination, the contribution value based on the consumption.

11. The apparatus of claim 10, wherein the data combination is a merged value, the combining component configured to merge a first value associated with the first data contribution with a second value associated with the second data contribution to create the merged value.

12. The apparatus of claim 11, the combining component configured to determine a confidence level associated with the merged value.

13. The apparatus of claim 12, the combining component configured to assign a weight to at least one of the first data contribution or the second data contribution, wherein the confidence level is based on the weight.

14. The apparatus of claim 10, wherein the data combination is a joined dataset, the combining component configured to join a first dataset associated with the first data contribution with a second dataset associated with the second data contribution to create the joined dataset.

15. The apparatus of claim 10, the aggregation component further configured to aggregate the plurality of data contributions based on a search criteria, the first data contribution and the second data contribution included in a set of results matching the search criteria.

16. The apparatus of claim 10, the valuation component configured to associate a reputation value with the at least one contributor, the contribution value based on the reputation value.

17. The apparatus of claim 10, the tracking component configured to monitor a revenue stream associated with the consumption.

18. The apparatus of claim 17, the tracking component configured to determine an allocation of the revenue stream earned by the at least one contributor, the allocation based on the contribution value.

19. The apparatus of claim 17, the combining component configured to insert an advertisement into a display of the data combination, the revenue stream including an advertising portion associated with the advertisement.

20. A computer program product for synthesizing data to facilitate providing information as a service, comprising:
a computer-readable storage medium comprising code for causing at least one computer to:
aggregate a plurality of data contributions;
combine a first data contribution with a second data contribution to create a data combination, wherein the data combination is at least one of a merged value or a joined dataset;
track a consumption of the data combination;
ascertain a contribution value associated with at least one contributor to the data combination, the contribution value based on the consumption; and
weight the contribution value according to a corresponding reputation value.
